(19) United States
(12) Patent Application Publication
(10) Pub. No.: US 2026/0062003 A1
(43) Pub. Date: Mar. 5, 2026

(54) TUNNEL DRIVING ASSISTANCE SYSTEM FOR A VEHICLE

(71) Applicants: HYUNDAI MOTOR COMPANY, Seoul (KR); KIA CORPORATION, Seoul (KR)

(72) Inventor: Sun Young Park, Hwaseong-si (KR)

(73) Assignees: HYUNDAI MOTOR COMPANY, Seoul (KR); KIA CORPORATION, Seoul (KR)

(21) Appl. No.: 19/197,014

(22) Filed: May 2, 2025

(30) Foreign Application Priority Data
Aug. 28, 2024 (KR) 10-2024-0116143

(51) Int. Cl. B60W 30/16; B60W 10/04; B60W 10/18; B60W 10/20; B60W 30/045; B60W 30/12; B60W 30/18; B60W 50/14; G06V 20/58

(52) U.S. Cl. CPC B60W 30/162; B60W 10/04; B60W 10/18; B60W 10/20; B60W 30/045; B60W 30/12; B60W 30/18063; B60W 50/14; B60W 2050/146; B60W 2420/403; B60W 2520/10; B60W 2540/215; B60W 2552/05; B60W 2552/10; B60W 2554/20; B60W 2554/4041; B60W 2710/18; B60W 2710/20; B60W 2720/106; B60W 2754/30; G06V 20/582

(57) ABSTRACT

A tunnel driving assistance system includes a determination unit configured to determine whether a vehicle enters a tunnel and whether a vehicle exits a tunnel while the vehicle is driven. The system also includes a control unit configured to perform at least one of an entry/exit assistance control configured to assist driving of the vehicle or a tunnel driving assistance control configured to assist driving of the vehicle.

### CROSS-REFERENCE TO RELATED APPLICATION(S)

This application claims the benefit of and priority to Korean Patent Application No. 10-2024-0116143, filed on Aug. 28, 2024, in the Korean Intellectual Property Office, the entire disclosure of which is herein incorporated by reference.

### TECHNICAL FIELD

The present disclosure relates to a tunnel driving assistance system for improving vehicle driving safety and convenience by assisting tunnel driving.

### BACKGROUND

In today's society, road traffic continues to increase, and thus drivers have to concurrently consider both safety and convenience in various driving environments.

In particular, tunnel driving presents a unique driving environment distinct from ordinary roads and has characteristics of interior darkness, limited ventilation and airflow, and the difficulty of evacuation in the event of an accident. The unique driving environment in tunnels may impose additional psychological burdens on drivers and may increase the probability of accidents occurring due to momentary judgment errors or operational mistakes.

The primary risk factors in tunnel driving include the difficulty in securing adequate visibility due to sudden changes in illumination inside and outside tunnels, psychological pressure from the proximity of surrounding structures, and the effects of air resistance and turbulence on vehicle behavior.

Therefore, it is necessary to propose the implementation of driving assistance systems for enhancing safety and improving driver convenience during tunnel driving when driving through a tunnel having the risk factors.

The foregoing described as the background art is intended merely to aid in the understanding of the background of the present disclosure. The foregoing described as the background art is not intended to mean that the present disclosure falls within the purview of the related art already known to those having ordinary skill in the art.

### SUMMARY

The present disclosure aims to provide a tunnel driving assistance system for improving vehicle driving safety and convenience by assisting tunnel driving.

The technical subjects pursued in the present disclosure may not be limited to the above mentioned technical subjects. Other technical subjects which are not mentioned may be clearly understood, through the following descriptions, by those having ordinary skill in the art.

The tunnel driving assistance system according to an embodiment of the present disclosure for addressing the aforementioned task includes a determination unit configured to determine whether the vehicle enters a tunnel and exits a tunnel while the vehicle is driven. The system also includes a control unit configured to perform at least one of an entry/exit assistance control configured to assist driving of the vehicle when the vehicle enters a tunnel or exits a tunnel, based on the determined tunnel entry and exit, or a tunnel driving assistance control configured to assist driving from a time at which the vehicle enters the tunnel until the vehicle exits the tunnel.

As described above, various embodiments of the present disclosure may enable tunnel driving assistance for vehicles to improve driving safety and convenience.

Advantageous effects obtainable from the present disclosure may not be limited to the above-mentioned effects, and other effects which are not mentioned may be clearly understood from the following descriptions by those having ordinary skill in the art to which the present disclosure pertains.

### BRIEF DESCRIPTION OF THE DRAWINGS

The above and other aspects, features, and advantages of the present disclosure should be more apparent from the following detailed description taken in conjunction with the accompanying drawings, in which:

FIG. 1 is a view illustrating an implementation example of a tunnel driving assistance system for a vehicle according to an embodiment of the present disclosure;

FIG. 2 is a view illustrating an operation section of a tunnel driving assistance system for a vehicle according to an embodiment of the present disclosure;

FIG. 3 is a flowchart illustrating a method for determining whether a vehicle enters a tunnel and whether the vehicle exits a tunnel according to an embodiment of the present disclosure; and

FIG. 4 is a view illustrating a control process of a tunnel driving assistance system for a vehicle according to an embodiment of the present disclosure.

### DETAILED DESCRIPTION

A specific structural or functional description of embodiments of the disclosure set forth in the present disclosure is merely intended to describe the embodiments according to the present disclosure. Therefore, the embodiments according to the present disclosure may be implemented in various forms, and the present disclosure should not be construed as being limited to the embodiments described in the present disclosure.

Various changes and modifications may be made to the embodiments according to the present disclosure, and therefore particular embodiments are illustrated in the drawings and described in the present disclosure. However, it should be understood that embodiments according to the concept of the present disclosure are not limited to the particular disclosed embodiments. Instead, the present disclosure includes all modifications, equivalents, and alternatives falling within the spirit and scope of the present disclosure.

Unless defined otherwise, all terms used herein, including technical and scientific terms, have the same meaning as those commonly understood by those having ordinary skill in the art to which the present disclosure pertains. Such terms as those defined in a generally used dictionary may be interpreted to have the meanings equal to the contextual meanings in the relevant field of art. Such terms should not be interpreted to have ideal or excessively formal meanings unless clearly defined in the present disclosure.

Hereinafter, embodiments set forth herein are described in detail with reference to the accompanying drawings, and the same or similar elements are given the same and similar reference numerals regardless of figure numbers, so duplicate descriptions thereof have been omitted.

As used in the following description of embodiments, the term “predetermined” means that, when a parameter is used in a process or algorithm, the value of the parameter has previously been determined. The numerical value of the parameter may be set at the beginning of the process or algorithm or during an interval when the process or algorithm is performed.

The terms “module” and “unit” used for the elements in the following description are given or interchangeably used in consideration of only the ease of writing the specification, and do not have distinct meanings or roles by themselves. When a controller, module, component, device, element, part, unit, or the like of the present disclosure is described as having a purpose or performing an operation, function, or the like, the controller, module, component, device, element, part, unit, or the like should be considered herein as being “configured to” meet that purpose or to perform that operation or function. Each controller, module, component, device, element, part, unit, and the like may separately embody or be included with a processor and a memory, such as a non-transitory computer readable media, as part of the apparatus.

In describing the embodiments set forth herein, a detailed description of known functions or configurations incorporated herein has been omitted when it is determined that the description may make the subject matter of the embodiments set forth herein unclear. In addition, it should be appreciated that the accompanying drawings are provided only for the sake of easy understanding of the embodiments set forth herein. The technical idea of the present disclosure is not limited to the accompanying drawings and includes all modifications, equivalents, or alternatives falling within the spirit and scope of the present disclosure.

Terms including an ordinal number such as “a first” and “a second” may be used to describe various elements, but the elements are not limited to the terms. The above terms are used merely for the purpose of distinguishing one element from other elements.

In the case where an element is referred to as being “connected” or “coupled” to any other elements, it should be understood that not only the element may be directly connected or coupled to the other elements, but also another element may exist therebetween. Contrarily, in the case where an element is referred to as being “directly connected” or “directly coupled” to any other element, it should be understood that no other element exists therebetween.

A singular expression may include a plural expression unless they are definitely different in a context.

As used herein, the expression “include” or “have” are intended to specify the existence of mentioned features, numbers, steps, operations, elements, components, or combinations thereof. The expression should be construed as not precluding the possible existence or addition of one or more other features, numbers, steps, operations, elements, components, or combinations thereof.

A unit or a control unit, such as a motor control unit (MCU) and a hybrid control unit (HCU), is merely a term widely used for naming a controller configured to control a specific function of a vehicle but does not mean a generic function unit.

A controller may include a communication device configured to communicate with a sensor or another control unit, a memory configured to store an operation system, a logic command, or input/output information, and at least one processor configured to perform determination, calculation, decision or the like, which are required for responsible function controlling.

An embodiment of the present disclosure provides a tunnel driving assistance system, which intervenes in the vehicle's driving control in consideration of distinct characteristics of tunnel driving and thus improves driving safety and convenience during tunnel driving. Hereinafter, with reference to each drawing, the tunnel driving assistance system according to an embodiment of the present disclosure is described.

Here, a tunnel refers to a passage constructed through the ground, beneath the sea, or through mountains to allow the passage of vehicles and other traffic and is distinct from fully open ordinary road by including an entrance and exit at both ends and the sides and upper surface between them enclosed by structures.

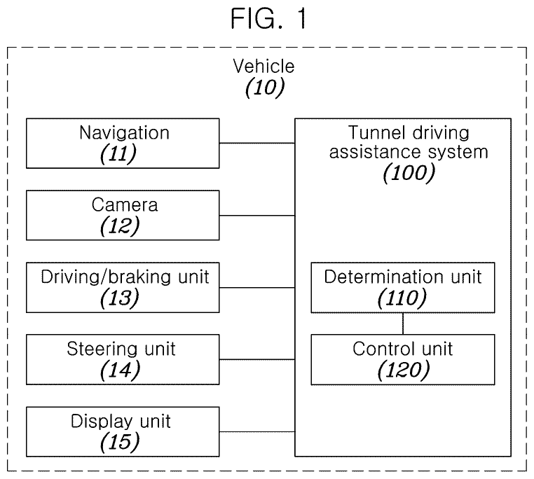

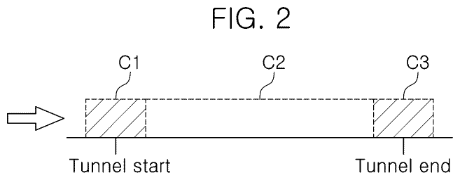

Hereinafter, with reference to FIGS. 1 and 2, the tunnel driving assistance system according to an embodiment of the present disclosure is described.

FIG. 1 is a view illustrating an implementation example of a tunnel driving assistance system for a vehicle according to an embodiment of the present disclosure. FIG. 2 is a view illustrating an operation section of a tunnel driving assistance system for a vehicle according to an embodiment of the present disclosure.

Referring to FIG. 1, the tunnel driving assistance system 100 for the vehicle may include a determination unit 110 and a control unit 120 and may be implemented in the vehicle 10. In this case, the vehicle 10 may include a navigation 11, a camera 12, a driving/braking unit 13, a steering unit 14, and a display unit 15 in addition to the tunnel driving assistance system 100. Meanwhile, FIG. 1 mainly illustrates configurations according to an embodiment of the present disclosure, and the vehicle 10 may be implemented to have more or fewer configurations.

The determination unit 110 may determine whether the vehicle 10 enters a tunnel and whether the vehicle 10 exits a tunnel. The control unit 120 may perform entry/exit assistance control for assisting driving of the vehicle 10 when the vehicle 10 enters a tunnel or exits a tunnel, based on the determined tunnel entry and exit. The control unit 120 may tunnel driving assistance control for assisting driving from a time at which the vehicle 10 enters the tunnel until the vehicle 10 exits the tunnel. To this end, the determination unit 110 may acquire information from the navigation 11, the camera 12, and the like. The control unit 120 may output a control command according to a determination result of the determination unit 110 and may control the driving/braking unit 13, the steering unit 14, the display unit 15, and the like.

More specifically, referring to FIG. 2, in an embodiment, the “tunnel entry” determined by the determination unit 110 may be referred to as a case in which the vehicle 10 is located within a predetermined distance before and after a starting point (entrance) of the tunnel. The “tunnel exit” may be referred to as a case in which the vehicle 10 is located within a predetermined distance before and after an end point (exit) of the tunnel. Here, the predetermined distance may be preset, and a specific value may vary according to embodiments.

In this case, the entry/exit assistance control according to an embodiment may be performed in a tunnel entry section C1 and a tunnel exit section C3, and the tunnel driving assistance control may be performed a section C2 between the tunnel entry section C1 and the tunnel exit section C3. Hereinafter, referring to FIG. 1 again, operations performed by the determination unit 110 and the control unit 120 are described in detail.

The determination unit 110 may receive navigation information on whether the vehicle 10 enters a tunnel and whether the vehicle 10 exits a tunnel, from the navigation 11 provided in the vehicle 10. The determination unit 110 may determine whether the vehicle 10 enters a tunnel and whether the vehicle 10 exits a tunnel based on the received navigation information.

For example, the navigation 11 may determine navigation information including a driving environment of the vehicle based on a current location and map information of the vehicle. The navigation information may include information on tunnel entry and tunnel exit. In this case, when navigation information on tunnel entry and tunnel exit is received from the navigation 11, the determination unit 110 may determine that the vehicle enters the tunnel or exits the tunnel.

On the other hand, the determination unit 110 may determine whether the vehicle 10 enters the tunnel or whether the vehicle 10 exits a tunnel based on an image photographed by the camera 12 provided in the vehicle 10. In this case, the determination unit 110 may determine whether the vehicle 10 enters the tunnel or whether the vehicle 10 exits the tunnel by additionally considering at least one of vehicle speed information or location information of the vehicle 10. Here, the camera 12 may be provided inside or outside the vehicle 10 to photograph the front of the vehicle 10, and the determination unit 110 may be configured to recognize information included in an image photographed by the camera 12. In addition, the determination unit 110 may acquire vehicle speed information from a speed sensor provided in the vehicle 10 and may acquire location information of the vehicle 10 from a navigation system, such as GPS.

For example, when an entrance of a tunnel is recognized or a sign indicating information for the tunnel is recognized from an image photographed through the camera 12, the determination unit 110 may determine a starting point of the tunnel, a length of the tunnel, and the like based on the recognized information. In addition, the determination unit 110 may determine a moving distance of the vehicle 10 through the vehicle speed information and the location information of the vehicle 10. The determination unit 110 may determine whether the vehicle 10 enters the tunnel and whether the vehicle 10 exits the tunnel through the determined starting point, length, and moving distance and the like.

In an embodiment, when navigation information may be received from the navigation 11, the determination unit 110 may determine whether the vehicle 10 enters the tunnel and whether the vehicle exits the tunnel primarily based on the navigation information. When navigation information may not be received, the determination unit 110 may determine whether the vehicle 10 enters the tunnel and whether the vehicle exits the tunnel based on the image photographed by the camera 12, the vehicle speed information, the location information, and the like.

The control unit 120 may perform entry/exit assistance control and tunnel driving assistance control according to a determination result of the determination unit 110. To this end, the control unit 120 may control the driving/braking unit 13, the steering unit 14, the display unit 15, and the like of the vehicle 10. More specifically, the driving/braking unit 13 may include components, such as a motor, an engine, and a hydraulic brake, used for driving or braking the vehicle 10, and the steering unit 14 may include a steering wheel. The control unit 120 may control acceleration, braking, and the like of vehicle 10 through the driving/braking unit 13 and the steering unit 14. Furthermore, the display unit 15 may include a cluster, a display, such as an audio, video, navigation, and telematics (AVNT) device, and a speaker. The control unit 120 may transfer information associated with control to a user of the vehicle 10, such as a driver. Hereinafter, the entry/exit assistance control and the tunnel driving assistance control are described.

The vehicle 10 may perform the entry/exit assistance control by restricting a creep torque of the vehicle 10 to be lower than or equal to a preset magnitude when entering the tunnel or exiting the tunnel. Here, the creep torque refers to the torque generated when a brake pedal is not pressed, and even without pressing an accelerator pedal, driving force may be generated by the creep torque. Accordingly, the control unit 120 may restrict the creep torque to be lower than or equal to a preset magnitude when the vehicle 10 enters the tunnel or exits the tunnel to cause the vehicle 10 to coast at a lower speed compared to a case in which the entry/exit assistance control is not performed. Thus, driving safety during tunnel entry and exit may be improved, when sudden changes in lighting inside and outside the tunnel make it difficult to recognize the surrounding environment (structures, other vehicles, and the like).

Furthermore, the control unit 120 may perform entry/exit control by considering other vehicles located around the vehicle 10. More specifically, in case that there is a preceding vehicle traveling within a preset distance ahead of the vehicle 10 when the vehicle 10 enters a tunnel or exits a tunnel, the control unit 120 may perform the entry/exit assistance control.

In this case, the control unit 120 may perform the entry/exit assistance control by restricting an acceleration torque of the vehicle 10 to be lower than or equal to a preset magnitude when the vehicle 10 enters the tunnel or exits the tunnel. More specifically, in case that a distance between the vehicle 10 and a preceding vehicle is reduced, the control unit 120 may restrict an acceleration torque of the vehicle 10 to be lower than or equal to a preset magnitude. As such, acceleration of the vehicle 10 toward the preceding vehicle is restricted when the vehicle 10 enters and exits a tunnel where it is difficult to recognize the surrounding environment so as to prevent a risk, such as a risk of the vehicle 10 approaching the preceding vehicle at high speed and colliding with the preceding vehicle.

In addition, the control unit 120 may control at least one of acceleration or braking of the vehicle 10 to maintain the distance between the vehicle 10 and the preceding vehicle to be greater than or equal to a preset distance. The control unit 120 may perform the entry/exit assistance control by increasing the preset distance when the vehicle 10 enters a tunnel or exits a tunnel.

In other words, the control unit 120 may basically perform an inter-vehicle distance maintenance function by controlling acceleration and braking of the vehicle 10 and control the distance to the preceding vehicle to be greater during the entry/exit assistance control compared to when the basic inter-vehicle distance maintenance function is being performed.

As such, when entering and exiting a tunnel where it is difficult to recognize the surrounding environment, a safe distance to the preceding vehicle is secured so as to prevent collision accidents and the like.

In addition, the control unit 120 may perform the tunnel driving assistance control by controlling steering of the vehicle to prevent the vehicle from deviating from a lane until the vehicle 10 exits the tunnel after entering the tunnel. For example, the vehicle 10 may be equipped with a lane deviation prevention function through steering control. The control unit 120 may perform the tunnel driving assistance control by forcing the lane deviation prevention function from entering a tunnel until exiting the tunnel even if the lane deviation prevention function is not activated. Thus, driving safety and convenience may be improved while the vehicle 10 is passing through the tunnel.

In addition, the control unit 120 may perform the tunnel driving assistance control by performing vehicle body stability control when the vehicle 10 changes a lane until the vehicle 10 exits the tunnel after entering the tunnel. Here, the vehicle body stability control may be performed using a method of correcting a behavior of a vehicle body through controlling braking, acceleration, and the like in an understeer and oversteer situation. A stability control function, such as electronic stability control, may be mounted in the vehicle 10.

In this case, the control unit 120 may perform the vehicle body stability control by forcing the lane deviation prevention function from entering a tunnel until the vehicle 10 exits the tunnel even if the vehicle body stability control is not activated. Thus, driving safety and convenience may be improved while the vehicle 10 is passing through the tunnel.

In addition, the control unit 120 may control the display unit 15 provided in the vehicle 10 to output a broadcast of a preset channel until the vehicle 10 exits the tunnel after entering the tunnel. Here, the display unit 15 may output radio, satellite broadcasting, and the like in a visual and auditory manner. The preset channel may vary depending on countries, regions, and the like and may be configured as a channel for, for example, transferring traffic information or broadcasting news. In this case, the control unit 120 may control, when information on transmission of a disaster broadcast is received through a preset channel, the display unit 15 to output a broadcast of the preset channel. For example, the control unit 120 may control, when the preset channel is a traffic broadcast channel and information on transmission of the disaster broadcast on the traffic broadcast channel is acquired, the display unit 15 to output the disaster broadcast of the preset channel without manipulation of the driver. Thus, the user of the vehicle 10, such as the driver and the like, is allowed to recognize an emergency/disaster situation.

Meanwhile, the control unit 120 may identify whether an assistance control function of which activation is configured by the user of the vehicle 10 is activated. The control unit 120 may perform, when the assistance control function is activated, at least one of entry/exit assistance control or tunnel driving assistance control. In other words, whether the assistance control function is activated may be selected according to intent of the user of the vehicle 10. Accordingly, control intervention may be allowed or prevented according to the entry/exit assistance control and the tunnel driving assistance control.

Meanwhile, the determination unit 110 may recognize a tunnel in front of the vehicle 10 and may determine whether entry to the recognized tunnel is blocked through at least one of the navigation 11 or the camera 12 provided in the vehicle 10, in addition to determining whether the vehicle 10 enters the tunnel and whether the vehicle exits the tunnel. For example, the determination unit 110 may determine whether the tunnel entry is blocked through acquiring, from the navigation 11, navigation information on a case that the vehicle 10 is approaching the tunnel to which entry is blocked. Alternatively, the determination unit 110 may determine whether the tunnel entry is blocked through recognizing “No Entry” signs or similar indications from an image photographed by the camera 12.

When the determination unit 110 has determined that entry to the recognized tunnel is blocked, the control unit 120 may output information on the entry blocking of the recognized tunnel through the display unit 15 provided in the vehicle 10. For example, the control unit 120 may audibly or visually output information indicating that entry to the tunnel ahead is blocked through the display unit 15 to allow the user of the vehicle 10 to recognize the fact that the entry to the tunnel is blocked.

Furthermore, the control unit 120 may, when determining that entry to the recognized tunnel is blocked, restrict, a creep torque, an acceleration torque, and a vehicle speed of the vehicle 10 to be lower than or equal to a preset magnitude through the driving/braking unit 13. The control unit 120 may prevent the vehicle 10 from entering the tunnel through stopping the vehicle 10 or the like when a condition is satisfied, such as the vehicle speed being lower than or equal to a reference speed.

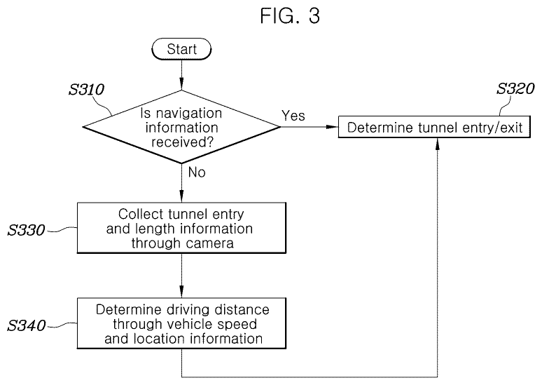

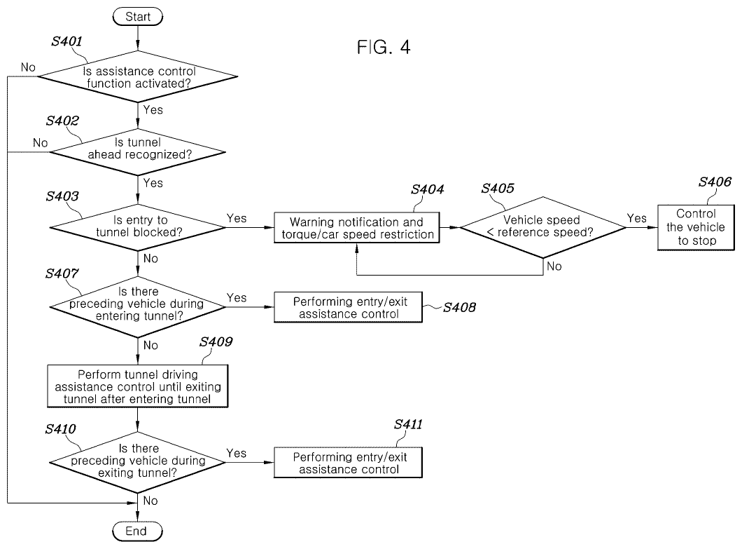

Hereinafter, through the flowcharts in FIGS. 3 and 4, a control process of the tunnel driving assistance system according to an embodiment of the present disclosure is described.

FIG. 3 is a flowchart illustrating a method for determining whether a vehicle enters a tunnel and whether the vehicle exits a tunnel according to an embodiment of the present disclosure.

FIG. 3 illustrate a process in which the termination unit 110 determines tunnel entry and tunnel exit, and the termination unit 110 may determine tunnel entry and tunnel exit (S320) according to whether navigation information is received from the navigation 11 (S310).

When the navigation information is received (Yes in S310), the determination unit 110 may determine tunnel entry and tunnel exit by primarily using the navigation information (S320). When the navigation information is not received (No in S310), the determination unit 110 may determine tunnel entry, a length of a tunnel, and the like through an image photographed through the camera 12 (S330) and may determine a moving distance through vehicle speed information and location information (S340) to determine tunnel entry and tunnel exit.

FIG. 4 is a view illustrating a control process of a tunnel driving assistance system for a vehicle according to an embodiment of the present disclosure.

Referring to FIG. 4, a performance process of entry/exit assistance control and tunnel driving assistance control performed by the control unit 120 is described.

First, before performing an assistance control operation, the control unit 120 determines whether the assistance control function is activated (S410) and following control processes are performed when the assistance control function is activated (Yes in S401). The assistance control operation is not performed when the assistance control function is not activated (No in S401).

Whe the assistance control function is activated (Yes in S401), when a tunnel is recognized in front of the vehicle 10 (yes in S402), the determination unit 110 may determine whether the recognized tunnel is blocked (S403). When it is determined that entry to the recognized tunnel is blocked (Yes in S403), the control unit 120 may output a warning notification corresponding to the entry blocking through the display unit 15 and may control a creep torque, an acceleration torque, and a vehicle speed of the vehicle 10 through the driving/braking unit 13 (S404). In addition, when the vehicle speed is dropped to be lower than or equal to a reference speed by control or manipulation of the driver (Yes in S405), the control unit 120 may prevent the vehicle 10 from entering the tunnel to which entry is blocked, through stop control (S406).

Meanwhile, when the entry to the recognized tunnel is not blocked (No in S403), the control described above is not performed and the vehicle 10 may enter the tunnel while the vehicle 10 is driving. Here, when it is determined that there is a preceding vehicle while the vehicle 10 is entering the tunnel (Yes in S407), the control unit 120 may perform entry/exit assistance control through the creep torque restriction, the acceleration torque restriction, and the inter-vehicle distance increase described above (S408).

When there is no preceding vehicle during the entry of the vehicle 10 to the tunnel, the tunnel driving assistance control may be performed instead of the entry/exit assistance control until the vehicle 10 exits the tunnel (S409). In this case, the control unit 120 may perform the tunnel driving assistance control through the lane deviation prevention control, the vehicle body stability control, and the disaster broadcast output described above.

The tunnel driving assistance control may end during exiting the tunnel of the vehicle 10, the entry/exit assistance control may be performed again during exiting the tunnel. Specifically, when there is a preceding vehicle during the vehicle 10 exits the tunnel (Yes in S410), the control unit 120 may perform the entry/exit assistance control through the creep torque restriction, the acceleration torque restriction, and the inter-vehicle distance increase described above (S411).

Although the present disclosure has been described and illustrated in conjunction with particular embodiments thereof as described above, it should be apparent to those having ordinary skill in the art that various improvements and modifications may be made to the present disclosure without departing from the technical idea of the present disclosure defined by the appended claims.

What is claimed is:

1. A tunnel driving assistance system comprising:
a determination unit configured to determine whether a vehicle enters a tunnel and whether the vehicle exits a tunnel while the vehicle is driven; and
a control unit configured to perform at least one of an entry/exit assistance control configured to assist driving of the vehicle when the vehicle enters a tunnel or exits a tunnel, based on whether the vehicle enters a tunnel and whether the vehicle exits a tunnel, or a tunnel driving assistance control configured to assist driving from a time at which the vehicle enters a tunnel until the vehicle exits the tunnel.

2. The tunnel driving assistance system of claim 1, wherein the determination unit is configured to:
receive navigation information on whether the vehicle enters a tunnel and exits a tunnel, from a navigation provided in the vehicle; and
determine whether the vehicle enters a tunnel and exits a tunnel based on the received navigation information.

3. The tunnel driving assistance system of claim 1, wherein the determination unit is configured to determine whether the vehicle enters a tunnel or whether the vehicle exits a tunnel based on an image photographed by a camera provided in the vehicle.

4. The tunnel driving assistance system of claim 3, wherein the determination unit is configured to determine whether the vehicle enters a tunnel or whether the vehicle exits a tunnel based on at least one of a vehicle speed information or a location information of the vehicle.

5. The tunnel driving assistance system of claim 1, wherein the control unit is configured to perform the entry/exit assistance control by restricting a creep torque of the vehicle to be lower than or equal to a preset magnitude when the vehicle enters a tunnel or exits a tunnel.

6. The tunnel driving assistance system of claim 1, wherein the control unit is configured to, when there is a preceding vehicle traveling within a preset distance ahead of the vehicle and when the vehicle enters a tunnel or exits a tunnel, perform the entry/exit assistance control.

7. The tunnel driving assistance system of claim 6, wherein the control unit is configured to perform the entry/exit assistance control by restricting an acceleration torque of the vehicle to be lower than or equal to a preset magnitude when the vehicle enters a tunnel or exits a tunnel.

8. The tunnel driving assistance system of claim 7, wherein the control unit is configured to, when a distance between the vehicle and the preceding vehicle is reduced, restrict the acceleration torque of the vehicle to be lower than or equal to the preset magnitude.

9. The tunnel driving assistance system of claim 7, wherein the control unit is configured to:
control at least one of acceleration or braking of the vehicle to maintain a distance between the vehicle and the preceding vehicle to be greater than or equal to a preset distance; and
perform the entry/exit assistance control by increasing the preset distance when the vehicle enters a tunnel or exits a tunnel.

10. The tunnel driving assistance system of claim 1, wherein the control unit is configured to perform the tunnel driving assistance control by controlling steering of the vehicle to prevent the vehicle from deviating from a lane until the vehicle exits a tunnel after entering the tunnel.

11. The tunnel driving assistance system of claim 1, wherein the control unit is configured to perform the tunnel driving assistance control by performing vehicle body stability control when the vehicle changes a lane until the vehicle exits a tunnel after entering the tunnel.

12. The tunnel driving assistance system of claim 1, wherein the control unit is configured to control a display unit provided in the vehicle to output a broadcast of a preset channel until the vehicle exits a tunnel after entering the tunnel.

13. The tunnel driving assistance system of claim 12, wherein the control unit is configured to, when information on transmission of a disaster broadcast is received through the preset channel, control the display unit to output a broadcast of a preset channel.

14. The tunnel driving assistance system of claim 1, wherein the control unit is configured to:
confirm whether an assistance control function is activated by a user of the vehicle; and
when the assistance control function is activated, perform at least one of the entry/exit assistance control or the tunnel driving assistance control.

15. The tunnel driving assistance system of claim 1, wherein the determination unit is configured to:
recognize a tunnel in front of the vehicle; and
determine whether entry to the recognized tunnel is blocked through at least one of a navigation or a camera provided in the vehicle.

16. The tunnel driving assistance system of claim 15, wherein the control unit is configured to, when determining that entry to the recognized tunnel is blocked, output information on the entry blocking of the recognized tunnel through a display unit provided in the vehicle.

17. The tunnel driving assistance system of claim 15, wherein the control unit is configured to, when determining that entry to the recognized tunnel is blocked, restrict a creep torque of the vehicle to be lower than or equal to a preset magnitude.

18. The tunnel driving assistance system of claim 15, wherein the control unit is configured to, when determining that entry to the recognized tunnel is blocked, restrict an acceleration torque of the vehicle to be lower than or equal to a preset magnitude.

19. The tunnel driving assistance system of claim 15, wherein the control unit is configured to, when determining that entry to the recognized tunnel is blocked, restrict a vehicle speed of the vehicle to be lower than or equal to a preset magnitude.

20. The tunnel driving assistance system of claim 15, wherein the control unit is configured to, when determining that entry to the recognized tunnel is blocked and that a vehicle speed of the vehicle is lower than or equal to a preset reference speed, stop the vehicle.
